(19) United States
(12) Patent Application Publication
(10) Pub. No.: US 2018/0174249 A1
(43) Pub. Date: Jun. 21, 2018

(54) POWER SUPPLY SYSTEM, CONTROL APPARATUS, POWER RECEPTION APPARATUS, TERMINAL DEVICE, POWER CONTROL METHOD AND NON-TRANSITORY COMPUTER READABLE MEDIUM

(71) Applicant: Toshiya OKABE, Tokyo (JP)

(72) Inventor: Toshiya OKABE, Tokyo (JP)

(21) Appl. No.: 15/128,460

(22) PCT Filed: Jan. 21, 2015
(86) PCT No.: PCT/JP2015/000271

§ 371 Date: Sep. 23, 2016

(51) Int. Cl. G06Q 50/06; G06Q 30/04

(52) U.S. Cl. CPC G06Q 50/06; G06F 1/28; G06Q 30/04

(57) ABSTRACT

A power supply system includes a power reception unit capable of supplying power to an electrical device; a control unit that controls the supply of power from the power reception unit; and a billing-information table that indicates a condition for allowing the supply of power from the power reception unit to the electrical device. The control unit acquires a user identifier corresponding to a user of the electrical device and also acquires at least one of a service identifier corresponding to the power reception unit and an electrical-device identifier corresponding to the electrical device; refers to the billing-information table; and determines whether or not power can be supplied to the electrical device based on a combination of the user identifier with at least one of the service identifier and the electrical-device identifier.

### TECHNICAL FIELD

The present invention relates to a power supply system, a control apparatus, a power reception apparatus, a terminal device, a power control method and a program. For example, the present invention relates to a power supply control technique capable of flexibly determining electric energy (i.e., amount of electric power) that a user receives through a power supply service and an electric power charge (i.e., fee for electric power supply) thereof.

### BACKGROUND ART

In recent years, a power supply service through which power is supplied to an electrical device (or an electric appliance) and the like which a user possess when the user is away from his/her house or office has been proposed.

For example, Patent Literature 1 discloses a configuration in which an electric power charge (i.e., electric power fee) is calculated based on an electric charge menu offered by an electric power company with which user's household has a contract when the user charges his/her electric vehicle at a charging stand and the calculated electric power charge is added to the electric power charge of the user's household. Further, Patent Literature 1 discloses that when an electric power company that has supplied power for charging an electric vehicle differs from an electric power company with which the user's household has a contract, a power transaction could be performed between these electric power companies.

By the way, a power network system called Digital Grid (registered trademark) has been proposed as a new power network (see Patent literature 2 and Non-patent literature 3).

Digital Grid (registered trademark) is a power network system in which a power network is partitioned into small-sized cells and these cells are asynchronously interconnected. That is, voltages, phases, and frequencies of power used in the plurality of interconnected power cells are asynchronous to each other. As a small power cell, each power cell may be for a single building, a single commercial facility, or the like. As a large power cell, each power cell may be for a prefecture, a municipality or the like. Each power cell naturally includes a load therein, and may also include a power generation facility or a power storage system.

Further, each power cell includes a power router which is a connection (e.g., a connection port) to connect with other power cells or a utility grid. All the power routers can communicate with a management server and the management server manages all the power routers in an integrated manner.

The power router includes a plurality of legs. Each leg includes a connection terminal and a power conversion unit, and an address is assigned to each leg. Note that the power conversion by the leg means converting AC to DC or DC to AC and changing the voltage, the frequency, and the phase of the power.

### CITATION LIST

### Patent Literature

Patent Literature 1: Japanese Unexamined Patent Application Publication No. 2013-037429
Patent Literature 2: Japanese Patent No. 4783453
Patent Literature 3: Japanese Unexamined Patent Application Publication No. 2011-182641

### SUMMARY OF INVENTION

### Technical Problem

As seen in the configuration disclosed in Patent Literature 1, at the present time, an electric power charges plan provided to users is substantially uniform among all power companies. It is common that an electric power company desires to provide universal services and avoids differentiating power charges as much as possible.

However, the electric power charges, originally, may be flexibly set according to a place where power is used, a relationship between the user and the power supply source, or the like.

The present invention has been made to solve the above-described problem and an object thereof is to provide a power supply system, a control apparatus, a power reception apparatus, a terminal device, a power control method and a program capable of flexibly determining electric energy (i.e., amount of electric power) that a user receives through a power supply service and an electric power charge (i.e., fee for electric power) thereof.

Other objects and novel features will be made more apparent from the following description in the specification and the accompanying drawings.

### Solution to Problem

A power supply system according to the present invention includes a power reception unit capable of supplying power to an electrical device; a control unit that controls the supply of power from the power reception unit; and a billing-information table indicating a condition for allowing the supply of power from the power reception unit to the electrical device; wherein the control unit acquires a user identifier corresponding to a user of the electrical device and also acquires at least one of a service identifier corresponding to the power reception unit and an electrical-device identifier corresponding to the electrical device; and the control unit refers to the billing-information table and determines whether or not power can be supplied to the electrical device based on a combination of the user identifier with at least one of the service identifier and the electrical-device identifier.

A control apparatus according to the present invention is configured to: acquire a user identifier corresponding to a user of an electrical device and also acquire at least one of a service identifier corresponding to a power reception unit and an electrical-device identifier corresponding to the electrical device; and refer to a billing-information table indicating a condition for allowing the supply of power from the power reception unit to the electrical device and determine whether or not power can be supplied to the electrical device based on a combination of the user identifier with at least one of the service identifier and the electrical-device identifier.

A power reception apparatus according to the present invention is connected to a control unit so that they can communicate with each other and capable of supplying power to an electrical device, wherein: the control unit acquires a user identifier corresponding to a user of the electrical device and also acquires at least one of a service identifier corresponding to a power reception unit and an electrical-device identifier corresponding to the electrical device; the control unit refers to a billing-information table and starts receiving power when the control unit determines power can be supplied to the electrical device based on a combination of the user identifier with at least one of the service identifier and the electrical-device identifier.

A terminal device according to the present invention is connected a control unit so that they can communicate with each other, the control unit being configured to control the supply of power from a power reception unit capable of supplying power to an electrical device, the terminal device being configured to receive a power supply charge from a control apparatus and output the power supply charge at certain intervals or at an end of the power supply.

A power control method according to the present invention includes a step for acquiring a user identifier corresponding to a user of an electrical device and also a step for acquiring at least one of a service identifier corresponding to a power reception unit and an electrical-device identifier corresponding to the electrical device; and a step for referring to a billing-information table and determining whether or not power can be supplied to the electrical device based on a combination of the user identifier with at least one of the service identifier and the electrical-device identifier.

A program related to the present invention includes the following steps for causing a control apparatus to execute: a step for acquiring a user identifier corresponding to a user of an electrical device and also a step for acquiring at least one of a service identifier corresponding to a power reception unit and an electrical-device identifier corresponding to the electrical device; and a step for referring to a billing-information table, and determining whether or not power can be supplied to the electrical device based on a combination of the user identifier with at least one of the service identifier and the electrical-device identifier.

### Advantageous Effects of Invention

According to the present invention, it is possible to provide a power supply system, a control apparatus, a power reception apparatus, a terminal device, a power control method and a program capable of flexibly determining electric energy that a user receives through a power supply service and electric power charge thereof.

### BRIEF DESCRIPTION OF DRAWINGS

FIG. 1 shows a structure of a power supply system 100 according to a first exemplary embodiment of the present invention;

FIG. 2 shows an operation of a power supply system 100 according to the first exemplary embodiment of the present invention; and

FIG. 3 shows an example of a billing-information table 130 according to the first exemplary embodiment of the present invention.

### DESCRIPTION OF EMBODIMENTS

### First Exemplary Embodiment

### (Structure)

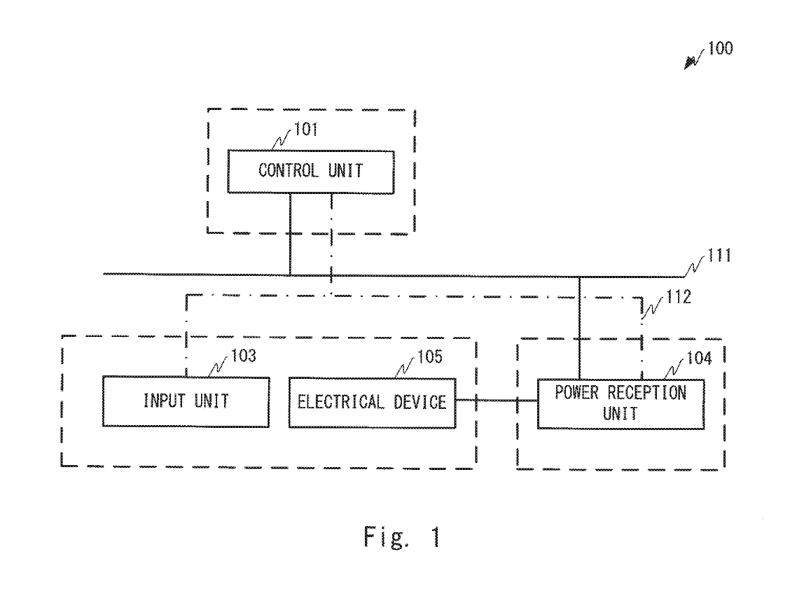

First, referring to FIG. 1, a configuration of a power supply system 100 according to a first exemplary embodiment of the present invention is explained. The power supply system 100 includes a control unit 101, an input unit 103, a power reception unit 104, and an electrical device 105.

The input unit 103 and electrical device 105 surrounded by a rectangle indicated by dotted lines are both apparatuses which are possessed or managed by a user.

The input unit 103 is a terminal device that can receive information input from the user and notify the control unit 101 of the input information. For example, the input unit 103 includes a management terminal device of a Home Energy Management System (HEMS) which has been installed in user's home, a personal computer (PC) which the user uses, a mobile terminal device such as a mobile phone, a smartphone, and a tablet and the like.

The electrical device 105 is a portable electrical device capable of receiving a power supply from the power reception unit 104, which is described later, in a place away from user's house or office or the like. For example, the electrical device 105 includes a PC or a mobile terminal device which the user uses in a place away from his/her house or office, an electrical vehicle (EV) and the like.

The power reception unit 104 surrounded by another rectangle indicated by dotted lines is an apparatus which is possessed or managed by an owner.

The power reception unit 104 is an apparatus which supplies power to the electrical device 105 in a place away from user's house or office or the like according to user's request. For example, the power reception unit 104 includes a charging stand of an EV, a charging apparatus for a mobile terminal device or the like, and a socket for charging or the like. The power reception unit 104 is connected with a power network 111, and supplies power from the power network 111 according to an instruction from the control unit 101.

Thereafter, a person, a corporation, or the like who installs these power reception units 104 is referred to simply as an “owner”. Examples of an owner include a manager of a shopping facility equipped with a charging stand on its property, a manager of a restaurant equipped with a charging apparatus or a socket for charging, and the like.

The control unit 101 surrounded by another rectangle indicated by dotted lines is an apparatus which is possessed or managed by a person or an corporation who operates a power supply service realized by the power supply system 100 (hereinafter referred to as an “operating entity”).

The control unit 101 is a control apparatus to control a power supply service and provide an instruction to receive power from the power network 111 and the like. For example, the control unit 101 includes a Digital Grid Controller (DGC) or the like.

The operating entity of the control unit 101 is typically an energy service provider (ESP). In the exemplary embodiment, it is assumed that the ESP which is independent of the electric power company manages the control unit 101. Note that the electric power company itself may also manage the control unit 101.

The power network 111 is a power network. The power network 111 according to the exemplary embodiment connects the control unit 101 and the power reception unit 104 through a power grid provided by the electric power company so that the control unit 101 and the power reception unit 104 can transmit/receive power to/from each other.

The communication network 112 is a communication network. The communication network 112 according to the exemplary embodiment connects the control unit 101 with the input unit 103 and the power reception unit 104 so that they can transmit/receive power to/from each other. Note that the power network 111 and the communication network 112 may be independent of each other, or may use a common infrastructure as in the case of power line communication.

### (Operation)

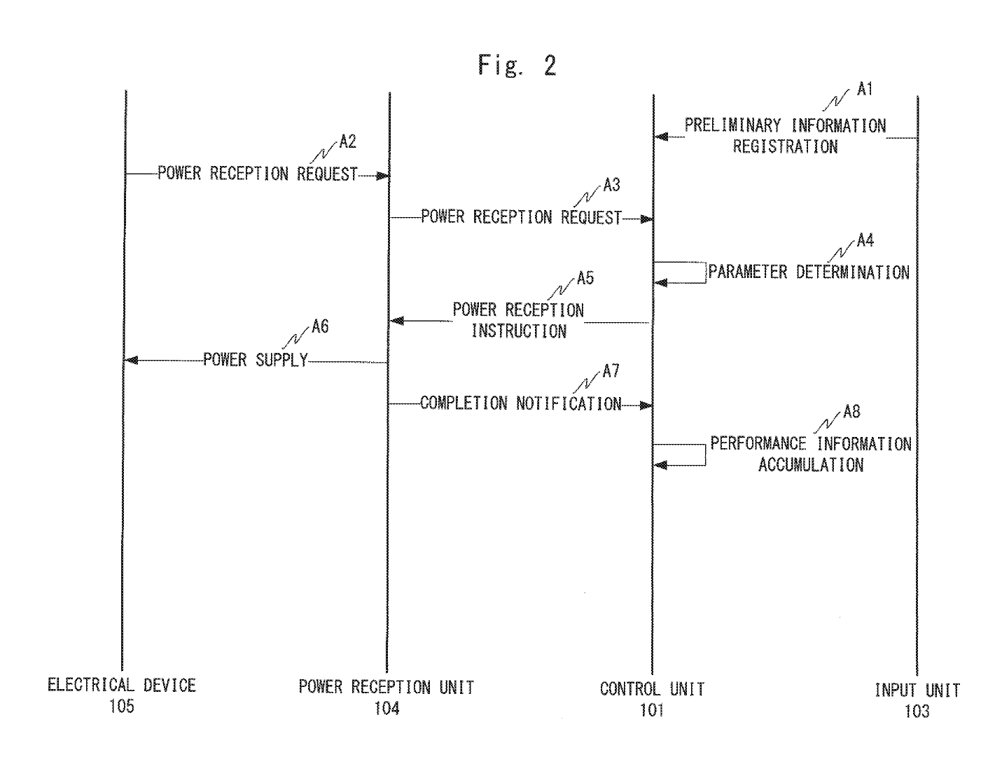

Next, by using a sequence diagram shown in FIG. 2, an operation of a power supply system 100 according to the first exemplary embodiment is explained.

A1: Preliminary Information Registration

A user inputs (or enters) information necessary to receive a power supply service to the input unit 103 in advance. In the exemplary embodiment, the user inputs a user identifier and preferably a service identifier. The input unit 103 sends the input information to the control unit 101. The control unit 101 associates information items received from the input unit 103 with each other and stores them in a predetermined storage area.

The user identifier is an identifier to uniquely identify the user. Further, the electrical-device identifier is an identifier to identify the electrical device 105.

The service identifier is an identifier to uniquely identify the owner of the power reception unit 104. Typically, when a shopping facility or a restaurant operates the power reception unit 104, the same service identifier (i.e., a common service identifier) is assigned to at least one power reception unit 104 installed in the shopping facility or the restaurant. Further, the same service identifier may be assigned to at least one power reception unit 104 installed in a certain limited area such as in the same building or in the same plant.

By registering the user identifier and the service identifier in advance while associating them with each other, it is possible to verify whether or not the user is eligible to receive the specific power supply service. The power supply service may include, for example, the following service.

An electronics manufacturer or a vehicle manufacturer sells the electrical device 105 together with a charging service that is effective over a predetermined period of time. In this case, the manufacturer provides the service identifier of the tie-up owner as a token of the above charging service. Accordingly, a purchaser can receive the charging service provided by the owner.

Further, a restaurant, a shopping facility and the like provide their own service identifiers as one of membership services and the like for users. In this way, the user can receive the charging service provided by the restaurant, the shopping facility and the like. The owner can use the charging service as an attraction and hence attract customers.

Further, the control unit 101 holds in advance a billing-information table 130 indicating a condition for allowing a power supply from the power reception unit 104 to the electrical device 105. The billing-information table 130 may hold, for example, an upper limit for usage and a remaining amount of the maximum usage related to the power supply service while associating them with each other in the form of a record indicating a condition for allowing the power supply.

Furthermore, the billing-information table 130 may hold at least one of the service identifier and the electrical-device identifier, the upper limit for usage, and the remaining amount of the maximum usage related to the power supply service while associating them with each other. Alternatively, the billing-information table 130 may hold the user identifier, at least one of the service identifier and the electrical-device identifier, the upper limit for usage, and the remaining amount of the maximum usage related to the power supply service while associating them with each other.

Further, the record indicating the condition for allowing the power supply may include a condition for the identifier of an eligible user for the power supply service or any other arbitrary conditions for the use in addition to the above information items. In particular, for example, it is possible to specify, as the condition for the user identifier of a user who can use the service identifier or the electrical-device identifier, that the user identifier should include predetermined member information, that the user identifier should include a history of use of a predetermined shop or the like, that the user identifier should be a user identifier of a user who possesses a coupon or the like related to the shop or the like. In this case, even if the user identifier is not directly defined in the record indicating the condition for allowing the power supply, the control unit 101 refers to other tables or the like, specifies the user identifier that meets the above condition for use (e.g., including a history of use, a coupon or the like), and determines whether or not power can be supplied to the user.

The upper limit for usage is an upper limit for electric energy that can be supplied, and defined by a combination of the specific user identifier and at least one of the service identifier and the electrical-device identifier. For example, when a user identifier A, a service identifier B, and an upper limit for usage of 10 kW are associated with each other in the billing-information table 130, a user A can repeatedly receive power from the power reception unit 104 having a service identifier B for an arbitrary electrical device 105 until the total amount of power supply reaches 10 kW. Further, when a user identifier C, an electrical-device identifier D, and an upper limit for usage of 10 kW are associated with each other in the billing-information table 130, a user C can repeatedly receive power from an arbitrary power reception unit 104 for the electrical device 105 having the electrical-device identifier D until the total amount of power supply reaches 10 kW.

The remaining amount of the maximum usage is an amount of electric energy obtained by subtracting an amount of electric energy that has already been received from the upper limit for the usage and defined by a combination of the specific user identifier and at least one of the service identifier and the electrical-device identifier. For example, when the user identifier A, the service identifier B, and the upper limit for usage of 10 kW are associated with each other in the billing-information table 130 and when the user A has already used the amount of power of 8 kW, the user A can further receive 2 kWh, which is recorded as the remaining amount of the maximum usage from the power reception unit 104 of the service identifier B that can be used for an arbitrary electrical device 105. Further, when the user identifier C, the electrical-device identifier D, and the upper limit for usage of 10 kW are associated with each other in the billing-information table 130 and when the user C has already used the amount of power of 8 kW, the user C can further receive 2 kWh, which is recorded as the remaining amount of the maximum usage from an arbitrary power reception unit 104 that can be used for the electrical device 105 of the electrical-device identifier D.

Note that instead of using the upper limit for the usage, any parameter to define the upper limit for the usage of power such as the upper limit for the charge (i.e., fee) that is obtained by converting the electric energy into the charge (i.e., fee) and the deadline for the usage defining the usage period of power may be employed. Further, instead of using the remaining amount of the maximum usage, any parameter to define the remaining amount of available power such as a remaining amount of the maximum charge (i.e., the maximum fee) and a remaining usage period may be employed.

Note that the manager of a power supply service (e.g., ESP) may define the contents of the billing-information table 130 in advance. Further, a service provider may use means similar to the electrical device 105 and register the contents of the billing-information table 130 in the control unit 101. For example, a manufacturer can create a record of a user who has bought a manufacturer's product by using a user identifier of the user and an electrical-device identifier of the product as keys. Alternatively, the manufacturer may add a service identifier to identify the owner of the power reception unit 104 as a key.

A2: Power Reception Request

The user inputs information to request the start of use of the power supply service to the power reception unit 104 installed in a place away from his/her house or office or the like when the user desires a power supply such as charging of the electrical device 105 possessed by the user in that place or the like. In the exemplary embodiment, the user inputs a user identifier and preferably an electrical-device identifier.

The user may input the user identifier through an input interface provided in the power reception unit 104. The input interface includes, for example, a reader to read a card or the like in which the user identifier is recorded, a communication interface to receive the user identifier sent from the user's mobile terminal device or the like, and a pointing device or the like by which the user directly inputs or selects the user identifier.

If the electrical device 105 is an EV, the power reception unit 104 may usually obtain the electrical-device identifier of the electrical device 105 through a dedicated charging interface. If the electrical device 105 is a mobile terminal device, the power reception unit 104 may obtain the electrical-device identifier of the electrical device 105 through a communication/charging interface. In cases other than the above cases, the power reception unit 104 may include an input interface, thus enabling the user to input the electrical-device identifier to the power reception unit 104. For example, the input interface includes a reader to read a card, a barcode or the like in which the electrical-device identifier is recorded, a communication interface to receive the electrical-device identifier sent from the electrical device 105 and the like, and a pointing device for enabling the user to directly input or select the electrical device identifier, and the like.

A3: Power Reception Request

The power reception unit 104 adds a service identifier in the information obtained at A2 and sends them to the control unit 101. In the exemplary embodiment, the power reception unit 104 is associated with a specific service identifier in advance and holds the service identifier in a predetermined storage area.

A4: Power Supply Parameter Determination

The control unit 101 determines whether or not power can be supplied based on the received user identifier and at least one of the service identifier and the electrical-device identifier.

Preferably, the control unit 101 first acquires the service identifier, which has been associated with the user identifier in advance at A1, by using the user identifier included in the power reception request sent at A3 as a key. Further, the control unit 101 determines whether or not the specified service identifier matches the service identifier included in the power reception request sent at A3. In this way, it is possible to verify whether or not the user is eligible for the charging service or the like.

Note that, as a matter of course, the control unit 101 can perform various determinations as to the allowance of power supply other than the above-described determinations according to the condition for allowing the power supply defined in the billing-information table 130. For example, when at least one of the service identifier and the electrical-device identifier, the upper limit for the usage, and the remaining amount of the maximum usage related to the power supply service are defined as the condition for allowing the power supply, the control unit 101 acquires the corresponding upper limit for the usage and the remaining amount of the maximum usage from the billing-information table 130 by using at least one of the service identifier and the electrical-device identifier related to the power reception unit 104 as a key. Further, when the remaining amount of the maximum usage is more than zero, the control unit 101 permits the supply of power up to the upper limit for a charge (i.e., the upper limit for a fee).

Alternatively, when the user identifier and a predetermined condition for use are defined as the condition for allowing the power supply, the control unit 101 acquires the condition for use from the billing-information table 130 by using the user identifier included in the power reception request sent at A3 as a key. Further, when the user identifier meets the condition for use, the control unit 101 permits the supply of power. For example, when the condition for allowance in which the user identifier is associated with one of the service identifier and the electrical-device identifier does not exist, the above-described determination based on the condition may be performed.

Next, the control unit 101 refers to the billing-information table 130 and acquires the remaining amount of the maximum usage associated with the user identifier and at least one of the service identifier and the electrical-device identifier.

When there is no corresponding record or the remaining amount of the maximum usage is zero, the control unit 101 determines that the power cannot be supplied. On the other hand, when the remaining amount of the maximum usage has a positive value, the control unit 101 determines that the power can be supplied.

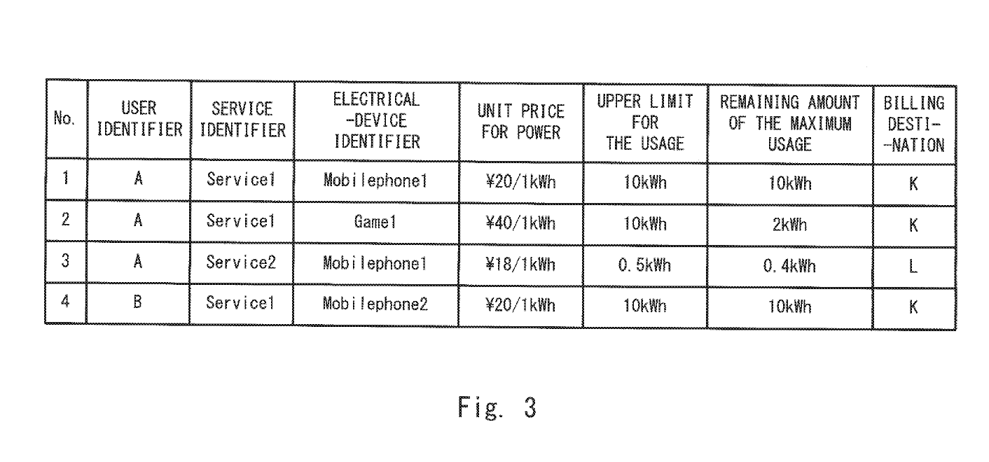

For example, when the control unit 101 holds the billing-information table 130 shown in FIG. 3 and a user identifier “A”, a service identifier “Service1”, and an electrical-device identifier “Game1” are input thereto, the control unit 101 identifies a record No. “2” by using these identifiers as keys. Further, the control unit 101 acquires the remaining amount of the maximum usage of “2 kWh” related to the record “2”. At this point, since 2 kWh is larger than zero, the control unit 101 determines that the power can be supplied in response to this power reception request.

A5 to A6: Power Supply Instruction, Power Reception Instruction, Power Supply

The control unit 101 sends a power reception instruction to the power reception unit 104 when the control unit 101 determines that the power can be supplied at A4.

The power reception unit 104 starts receiving power from the power network 111 according to the power reception instruction.

A7: Completion Notification

The power reception unit 104 sends a completion notification to the control unit 101 when the power reception unit 104 detects the completion of the power reception. It is desirable that the completion notification include the amount of received electric power. For example, when the power supply to the electrical device 105 is stopped because it is fully charged, the power reception unit 104 may determine that the power reception has been completed.

Alternatively, the control unit 101 may monitor the amount of power supplied from the power network 111 to the power reception unit 104 and when the amount of supplied power reaches the remaining amount of the usage, instruct the power reception unit 104 to stop the power reception. In this case, since the control unit 101 can recognize the amount of received power, the power reception unit 104 does not need to send the completion notification to the control unit 101.

A8: Performance Information Accumulation

The control unit 101 records the performance of provision of the power supply service related to A1 to A7 in the billing-information table 130. In the exemplary embodiment, the control unit 101 updates the value of the remaining amount of the maximum usage recorded in the billing-information table 130, which is associated with the user identifier and at least one of the service identifier and the electrical-device identifier, with a value obtained by subtracting the amount of received power from the remaining amount of the maximum usage.

For example, when the control unit 101 holds the billing-information table 130 shown in FIG. 3 and the electrical device having the identifier “Game1” associated with the user identifier “A” has received 0.5 kWh from the power reception unit 104 having the service identifier “Service1”, the control unit 101 updates the remaining amount of the maximum usage of the record “2” in which these identifiers are keys. The updated value becomes 1.5 kWh, which is obtained by subtracting 0.5 kWh from the pre-update (i.e., original) remaining amount of the maximum usage of “2 kWh”.

### (Effect)

According to the first exemplary embodiment, the control unit 101 determines whether or not power can be supplied based on the user identifier and at least one of the service identifier and the electrical-device identifier. Accordingly, it is possible to supply the power to the user while charging the fee for the supplied power to the person or corporation other than the user. Further, the person or corporation to whom the power fee is charged can develop a product and/or a service including the electric power fee and provide it/them to the user. Alternatively, the person or corporation to whom the power fee is charged (hereinafter referred to as a “billing destination”) can attract the user to their shops and the like by providing the power.

### Second Exemplary Embodiment

A power supply system 100 according to a second exemplary embodiment is characterized in that the control unit 101 specifies the electric power charge and the billing destination related to the power which the electrical device 105 has received. An operation of the power supply system 100 to realize the above-described features is explained with particular emphasis on a difference inform than that in the first exemplary embodiment. As for the remaining features, the structure and operation of the second exemplary embodiment are similar to those of the first exemplary embodiment.

### (Structure)

The billing-information table 130 in the second exemplary embodiment further holds a unit price for power and a billing destination in addition to various information items held in the billing-information table 130 according to the first exemplary embodiment. The unit price for power and the billing destination are associated with the user identifier and at least one of the service identifier and the electrical-device identifier.

The unit price for power is a price for unit power which is charged when the power is received in an entity corresponding to a combination of the user identifier and at least one of the service identifier and the electrical-device identifier. For example, when the unit price for power is 20 yen per kWh, 20 yen is charged every time the user receives the power of 1 kWh.

FIG. 3 shows an example of a billing-information table 130 according to the exemplary embodiment. For example, the record No. “2” indicates that when a user having a user identifier “A” charges the electrical device 105 having an electrical-device identifier “Game1” at the power reception unit 104 having a service identifier “Service1”, the unit price for power is “40 yen per kWh”; the user is able to use the power up to the upper limit for the usage of“10 kWh”; the current remaining amount of the maximum usage is “2 kWh”; and the fee for the used power is charged to a billing destination “K”.

### (Operation)

A1 to A7: The steps A1 to A7 are performed in the same way as those in the first exemplary embodiment.

A8: Performance Information Accumulation

The control unit 101 calculates the electric power charge related to a provision of the power supply service related to A1 to A7 and specifies the billing destination.

First, the control unit 101 refers to the billing-information table 130 and acquires the unit price for power and the billing destination associated with the user identifier and at least one of the service identifier and the electrical-device identifier. Next, the control unit 101 calculates the electric power charge by multiplying the amount of received power by the unit price for power.

For example, when the control unit 101 holds the billing-information table 130 shown in FIG. 3 and the electrical device having the electrical-device identifier “Game1” associated with the user identifier “A” has received 0.5 kWh from the power reception unit 104 having the service identifier “Service1”, the control unit 101 acquires the unit price for power “40 yen per 1 kWh” and the billing destination “K” from the record “2” in which these identifiers are keys. The electric power charge is calculated by multiplying the unit price for power 0.5 kWh by the amount of received power “40 yen per 1 kWh”.

### (Effect)

According to the second exemplary embodiment, the control unit 101 specifies the electric power charge and the billing destination for the power which the electrical device 105 has received. Accordingly, it is possible to supply the power to the user while charging the fee for the supplied power to the billing destination.

### Third Exemplary Embodiment

A power supply system 100 according to a third exemplary embodiment is characterized in that the control unit 101 changes the electric power charge (i.e., power fee) and/or determines whether or not power can be supplied to the user according to the relationship between a user and an owner, in particular, according to the form of use of a service or the like provided by the owner. In this way, when the owner is a manager of a restaurant or the like, he/she can develop a billing measure so that users are encouraged to perform specific actions while attracting uses by the provision of a charging service.

An operation of the power supply system 100 to realize the above-described features is explained with particular emphasis on a difference inform than that in the second exemplary embodiment. As for the remaining features, the structure and operation of the third exemplary embodiment are similar to those in the second exemplary embodiment.

### (Operation)

A1: The step A1 is performed in the same way as that in the first exemplary embodiment.

A2: Power Reception Request

The user may input information to measure a time period in which a user stays at a shop of an owner to the power reception unit 104 in addition to the operation shown in the first exemplary embodiment. For example, the power reception unit 104 can read time information recorded in a receipt that is handed to a user when the user purchases food and/or drink.

A3: Power Reception Request

The power reception unit 104 may send the time information acquired at A2 to the control unit 101 in addition to performing the operation shown in the first exemplary embodiment.

A4 to A5: The steps A4 to A5 are performed in the same way as those in the first exemplary embodiment.

A6: Power Supply Instruction, Power Reception Instruction, Power Supply

The control unit 101 may perform control to change the unit price for power based on the user identifier and the service identifier in addition to the operation shown the first exemplary embodiment. For example, the control unit 101 may change the unit price for power according to the history (or frequency or the like) of use of the shop of the owner by the user. It is assumed that the control unit 101 associates a history of provision of a power supply service such as a history of charging including date and time with the user identifier and records them in a predetermined storage area. In this case, the control unit 101 refers to this history. Then, in cases in which the number of visits to the shop by a user having a specific user identifier in a certain period exceeds a threshold, for example, the control unit 101 performs control to reduce the unit price for power specified in the billing information table 130 when the control unit 101 supplies power to the user having the user identifier. In this way, the owner can encourage the user to visit the shop more frequently.

Additionally, the control unit 101 may perform control to change the unit price for power according to the form of use of the shop by the user.

For example, the control unit 101 may change the unit price for power according to the time period in which the user stays in the shop. The control unit 101 calculates a time elapsed till the current time from the time information acquired at A2 as the stay time. The control unit 101 changes the unit price for power according to the length of the stay time. For example, the unit price for power specified in the billing-information table 130 is employed for the first 30 minutes, and after that the unit price for power is increased by 5 yen for every 30 minutes. In this way, the owner can encourage the user to reduce the time period during which the user stays in the shop.

Further, the control unit 101 may change the unit price for power according to the length of the charging time. The power reception unit 104 measures the time period of the power supply to the electrical device 105 and notifies the control unit 101 thereof. For example, the control unit 101 employs the unit price for power specified in the billing-information table 130 for the first 30 minutes, and after that performs control so that the unit price for power is increased by 5 yen every 30 minutes. Accordingly, the owner can encourage the user to reduce the charging time.

Furthermore, the control unit 101 may change the unit price for power according to the time when the user visits the shop. For example, the power reception unit 104 notifies the control unit 101 of the start time of the power supply to the electrical device 105. The control unit 101 performs control so that the unit price for power is reduced or increased from the price specified in the billing-information table 130, for example, when the time of the user's visit is within a predetermined period of time. In this way, the owner can discourage users from using the facility for a long time during busy times and encourage them to visit the shop during off-peak times.

Alternatively, the control unit 101 may change the unit price for power according to the amount of money a user spends (hereinafter referred to as “expenditure”). For example, at A2, the power reception unit 104 reads the expenditure recorded in a receipt, and notifies the control unit 101 thereof. The control unit 101 performs control to reduce the unit price for power from the price specified in the billing-information table 130 or the like, for example, when the expenditure is larger than a predetermined threshold. In this way, the owner can encourage users to spend more money in the shop.

It is desirable that the control unit 101 associates these rules for changing unit price for power with the service identifier and the electrical-device identifier and holds them in the billing-information table 130 or other predetermined storage areas. The manager or owner of the power supply service can associate arbitrarily changing rules with the service identifier and the electrical-device identifier and register them in the control unit 101 in advance. Alternatively, the service identifier may directly include information indicating the above changing rules. For example, the service identifier may include numerical values or the like indicating rates at which the unit price for power changes according to the number of visits to the shop or the length of staying time.

Alternatively, the control unit 101 may change the condition related to the unit price for power or the allowance of the use according to the electrical device 105 which the user uses. For example, as shown as records “1” and “2” in the billing-information table 130 of FIG. 3, it is possible to define different unit prices for power according to the electrical-device identifier. Alternatively, it is possible to disable a specific electrical device 105 by registering no electrical-device identifier. The owner can discourages the user from using the game device by using some measures such as increasing the electric power charge (i.e., fee) for the game device or supplying no electric power to the game device.

Furthermore, when the power reception unit 104 can procure power from not only the power network 111 but also a power supply unit such as a storage battery or an electric generator and when the power supply unit has excess electric energy, the control unit 101 can supply electric energy that corresponds to the excess electric energy to the electrical device 105 for relatively low unit price for power. The excess electric energy is, out of the whole amount of electric energy generated or accumulated by the power supply unit, electric energy which is unlikely to be used for the time being. The owner can register, if necessary, the excess electric energy in the control unit 101 at any time. Further, the control unit 101 may define a threshold in advance, monitor the amount of generated power or accumulated electric energy in the power supply unit, and when the amount of the generated or accumulated electric energy exceeds the above threshold, regard the exceeding electric energy as excess electric energy. Note that the threshold is not necessarily a fixed value and may be defined so as to change according to an arbitrary parameter such as a time period, a temperature, or the like.

A7 to A8: The steps A7 to A8 are performed in the same way as those in the first exemplary embodiment.

### (Effect)

According to the third exemplary embodiment, the control unit 101 changes the electric power charge (i.e., fee) and/or determines whether or not power can be supplied to the user according to the relationship between a user and an owner, in particular, according to the form of use of a service or the like provided by the owner. In this way, it is possible to develop a billing measure so that users are encouraged to perform specific actions while attracting the users.

### Fourth Exemplary Embodiment

A power supply system 100 according to a fourth exemplary embodiment is characterized in that the control unit 101 notifies the user of information related to the electric power charge, the amount of supplied power or the like. An operation of the power supply system 100 to realize the above-described features is explained with particular emphasis on a difference inform than those in the first to third exemplary embodiments. As for the remaining features, the structure and operation of the fourth exemplary embodiment are similar to those in the first to third exemplary embodiments.

### (Operation)

A1 to A5: The steps A1 to A5 are performed in the same way as those in the first exemplary embodiment.

A6: Power Supply Instruction, Power Reception Instruction, Power Supply

The control unit 101 notifies the user of information related to the electric energy supplied to the electrical device 105 and the electric power charge related to the electric energy or the like in addition to performing the operations in the first to third exemplary embodiments. The control unit 101 outputs these information items to output means included in the power reception unit 104, an application of a mobile terminal device of the user which is connected with the control unit 101 so that they can communicate with each other, or the like. Preferably, the control unit 101 updates the above electric energy and the electric power charge and outputs the updated information at regular intervals. Accordingly, it is possible to inform the user in an up-to-date manner of the used electric energy and the electric power charge and thus encourage the user to use an appropriate charging service.

A7: The step A7 is performed in the same way as those in the first to third exemplary embodiments.

A8: Performance Information Accumulation

The control unit 101 notifies the user of the final values of the electric energy supplied to the electrical device 105, the electric power charge related to the electric energy or the like in addition to performing the operations in the first to third exemplary embodiments.

### (Effect)

According to the fourth exemplary embodiment, the control unit 101 notifies the user of the information related to the electric power charge, the amount of supplied power or the like. In this way, it is possible to encourage the user to use an appropriate charging service.

### Other Exemplary Embodiment

Note that the present invention is not limited to the above exemplary embodiments, and modifications can be made as appropriate without departing from the scope of the invention. For example, needless to say, the present invention can be implemented by combining any of the first to ninth exemplary embodiments.

Further, in the above exemplary embodiments, although the present invention has been described as being mainly a hardware configuration, it is not limited to this, and the present invention can be achieved by causing a CPU (Central Processing Unit) to execute arbitrary processes by a computer program. In this case, the computer program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present invention has been described with reference to the exemplary embodiments, the present invention is not limited by the above. Various modifications, obvious to those skilled in the art, can be made to the configurations and details of the present invention.

The present application claims priority rights of and is based on Japanese Patent Application No. 2014-060031 filed on Mar. 24, 2014 in the Japanese Patent Office, the entire contents of which are hereby incorporated by reference.

### REFERENCE SIGNS LIST

100 power supply system
101 control unit
103 input unit
104 power reception unit
105 electrical device
111 power network
112 communication network
130 billing-information table

1. A power supply system comprises:
a power reception apparatus capable of supplying power to an electrical device;
a control apparatus configured to control the supply of power from the power reception apparatus; and
a billing-information table indicating a condition for allowing the supply of power from the power reception apparatus to the electrical device;
wherein the control apparatus acquires a user identifier corresponding to a user of the electrical device and also acquires at least one of a service identifier corresponding to the power reception apparatus and an electrical-device identifier corresponding to the electrical device; and
the control apparatus refers to the billing-information table, and determines whether or not power can be supplied to the electrical device based on a combination of the user identifier with at least one of the service identifier and the electrical-device identifier.

2. The power supply system according to claim 1, wherein
the billing-information table further contains electric power charge information;
the control apparatus acquires the user identifier and also acquires at least one of the service identifier and the electrical-device identifier;
the control apparatus refers to the billing-information table, and calculates a power supply charge for the electrical device based on the combination of the user identifier with at least one of the service identifier and the electrical-device identifier.

3. The power supply system according to claim 1, wherein
the billing-information table contains an upper limit for usage as the conditions for allowing the power supply;
the control apparatus acquires the user identifier and also acquires at least one of the service identifier and the electrical-device identifier;
the control apparatus refers to the billing-information table, and decides an amount of power supply to the electrical device based on a combination of the user identifier with at least one of the service identifier and the electrical-device identifier.

4. The power supply system according to claim 1, wherein
the billing-information table further contains billing destination information;
the control apparatus refers to the billing-information table, and decides a billing destination of a power supply charge for the electrical device based on a combination of the user identifier with at least one of the service identifier and the electrical-device identifier.

5. The power supply system according to claim 2, wherein
the control apparatus acquires, through the power reception apparatus, a time period of a stay of the user, a time at which the power reception apparatus is used, a time period of use of the power reception apparatus, or a number of times of use of the power reception apparatus, and changes the power supply charge.

6. The power supply system according to claim 2, wherein
the control apparatus outputs the calculated or changed power supply charge at certain intervals or at an end of the power supply.

7. A control apparatus is configured to:
acquire a user identifier corresponding to a user of an electrical device and also acquire at least one of a service identifier corresponding to a power reception apparatus and an electrical-device identifier corresponding to the electrical device; and
refer to a billing-information table indicating a condition for allowing the supply of power from the power reception unit to the electrical device and determine whether or not power can be supplied to the electrical device based on a combination of the user identifier with at least one of the service identifier and the electrical-device identifier.

8. A power reception apparatus is connected to a control apparatus so that they can communicate with each other and capable of supplying power to an electrical device, wherein
the control apparatus acquire a user identifier corresponding to a user of the electrical device and also acquires at least one of a service identifier corresponding to the power reception apparatus and an electrical-device identifier corresponding to the electrical device;
the control apparatus refer to a billing-information table, and starts receiving power when the control apparatus determine whether or not power can be supplied to the electrical device based on a combination of the user identifier with at least one of the service identifier and the electrical-device identifier.

9. A terminal device capable of receiving power from a power reception apparatus according to claim 8, the terminal device being connected to a control apparatus so that they can communicate with each other, the control unit being configured to control the supply of power from a power reception apparatus capable of supplying power to an electrical device, the terminal device being configured to receive a power supply charge from a control apparatus and output the power supply charge at certain intervals or at an end of the power supply.

10. A power control method comprising:
a step for acquiring a user identifier corresponding to a user of an electrical device and also a step for acquiring at least one of a service identifier corresponding to a power reception apparatus and an electrical-device identifier corresponding to the electrical device; and
a step for referring to a billing-information table and determining whether or not power can be supplied to the electrical device based on a combination of the user identifier with at least one of the service identifier and the electrical-device identifier.

11. A non-transitory computer readable medium storing a program for causing a control apparatus to execute:
a step for acquiring a user identifier corresponding to a user of an electrical device and also a step for acquiring at least one of a service identifier corresponding to a power reception apparatus and an electrical-device identifier corresponding to the electrical device; and
a step for referring to a billing-information table, and determining whether or not power can be supplied to the electrical device based on a combination of the user identifier with at least one of the service identifier and the electrical-device identifier.
